(19) United States
(12) Patent Application Publication
(10) Pub. No.: US 2008/0179068 A1
(43) Pub. Date: Jul. 31, 2008

(54) Holecutter

(76) Inventor: Tim Webb, Warwickshire (GB)

Correspondence Address: KIRSCHSTEIN, OTTINGER, ISRAEL;& SCHIFFMILLER, P.C., 425 FIFTH AVENUE, 5TH FLOOR, NEW YORK, NY, 10016-2223, US

(21) Appl. No.: 12/008,459

(22) Filed: Jan. 11, 2008

(30) Foreign Application Priority Data
Jan. 11, 2007 (GB) 0700595.2

(51) Int. Cl. A01B 45/00

(52) U.S. Cl. 172/22; 206/223

(57) ABSTRACT

A holecutter for creating holes in a golf course by both cutting a hole in the ground and removing the cut material comprises a receptacle, a cutting edge disposed at an aperture of the receptacle, an impact structure connected to the receptacle and arranged to deliver an impact to the receptacle to drive it into the ground and an ejecting structure disposed to eject the cut material from the receptacle. The ejecting structure of the holecutter is movable between an initial position and an ejected position by a geared drive acting between a guide and the impact structure. The impact structure comprises a grippable shaft that is slidably mounted on the guide which extends away from an end of the receptacle opposed to the aperture.

### FIELD OF THE INVENTION

The invention relates to holecutters, and specifically relates to holecutters for manual use in cutting holes on golf courses.

### BACKGROUND OF THE INVENTION

There is a need on golf courses to make holes for golf balls. A golf ball hole is typically a cylindrical flat bottomed shaft. The standard golf ball hole is defined as being 108 mm or 4.5 inches in diameter by 7 inches deep.

The holes must be cut in the material of the golf course, which is typically soil. Being made in a natural material, each hole is liable to degrade with use and requires regular maintenance. Eventually at the end of a hole's life, a new hole has to be made. The new hole must be carefully made without damaging the local topography of the course or the grass itself, which would otherwise affect play.

There are several existing holecutters for golf courses. The most commonly used is an auger, consisting of a cylinder mounted on a shaft with a pair of handles at the top. The lowermost edge of the holecutter is sharp and the holecutter is driven into the ground by applying a twisting and driving force to the top of the shaft. Although simple to use, it is difficult to remove the cut material such as the soil from the cylinder.

Another type of holecutter seeks to overcome this problem. In this case the cylinder is replaced by two cooperating halves which slide on runners located between twin shafts. A large hole is provided in the base of these holecutters through which the halves can move as one. A flat surface is provided at the top end of each half to function as anvil for the mallet. Once the hole has been made, the halves are pulled out of the ground by gripping an overhanging lip at the top end of each half, and then pulled upwardly out of their runners to separate the halves thereby facilitating the removal of the cut material. However, this requires the user to apply a strong force through his bare hands. It also requires precise hand-eye coordination to strike the flat surface at the top of each half.

There is another type of holecutter similar to the auger type holecutter, but differs in having an integral expeller to remove cut material without needing to use a split cylinder. This holecutter is shown in FIG. 1. A hollow cylinder is mounted on a shaft with handles at the distal end of the shaft. A rod with a looped portion at its lowermost end is slidably mounted within the cutting cylinder, with a portion of the rod extending upwardly through an aperture in the top of the cylinder. The top end of the rod is pivotably connected to a lever mounted about the shaft. Swinging the lever causes the rod to slide up and down. As the rod moves downwards, the looped portion of the rod presses against a plate slidably held within the cylinder compelling the plate to make an expelling stroke. The plate is maintained perpendicular to the walls of the chamber by guiding legs that extend upwardly through holes in the top of the cylinder, but is otherwise free to move.

The invention provides an improved holecutter having an integral means for driving a cutting edge into the ground, and also having an integral ejecting means for removing cut material from a receptacle of the holecutter.

### SUMMARY OF THE INVENTION

The invention provides a holecutter for cutting a hole in the ground and removing cut material, the holecutter comprising:

a receptacle;

a cutting edge disposed at an aperture of the receptacle;

an impact means connected to the receptacle and arranged to deliver an impact to the receptacle to drive it into the ground and comprising a grippable shaft slidably mounted on a guiding means which extends away from an end of the receptacle opposed to the aperture; and

an ejecting means disposed to eject the cut material from the receptacle, the ejecting means being movable between an initial position and an ejected position by a geared driving means acting between the guiding means and the impact means.

The receptacle is preferably substantially cylindrical. The cutting edge nay have any suitable shape. The cutting edge may be disposed around all or part of the receptacle.

The diameter of the aperture is preferably substantially the same size or larger than the diameter of a standard golf ball. Most preferably it corresponds exactly to the defined standard golf ball hole diameter, i.e., about 108 mm.

The shaft of the holecutter may be made grippable by gripping surfaces on the shaft, or by the provision of a handle, or handles, extending outwardly from an end region of the shaft distal to the receptacle and along a radius of the shaft. The handles may lie along a diameter of the shaft. The overall unextended length of the holecutter may be such that when the holecutter is placed on a surface, the end region is substantially at the waist level of an adjacent user who is standing on the same surface.

The shaft may be selectively lockable to the guiding means or the receptacle, and is preferably lockable to the guiding means when an end of the shaft is brought into contact with the receptacle.

A torque transfer means may be disposed between the shaft and the receptacle, for example a protrusion extending from the receptacle and a cooperating hole on the end of the shaft together forming an interlock.

The ejecting means preferably comprises a rod extending out through a hole in the receptacle and terminating in a first end, the other end of the rod being slidably received within and adapted to cooperate with the interior of the receptacle. The first end may be slidably received within and optionally project beyond the guiding means.

The guiding means may be integral with the ejecting means, and may comprise the rod extending out through a hole in the receptacle and terminating in a first end, the other end of the rod being slidably received within and adapted to cooperate with the receptacle to thereby form the ejecting means. The first end of the rod may terminate within the shaft and be restrained from becoming separated therefrom by a collar at a lower end of the shaft which is of narrower diameter then the first end of the rod.

It will be understood that the other end of the rod may be adapted to fit within the receptacle in many ways, for example by having a bulbous portion or a plate. The hole in the receptacle may form a friction fit with the rod.

Most preferably, the guiding means comprises a tube mounted on and extending away from the receptacle.

The receptacle may have additional holes to provide fluid communication between the atmosphere and the interior of the receptacle as it is being driven into the ground.

Preferably the geared driving means comprises a toothed portion provided on the rod between the first end and other end to engage with a cog of a winder mounted substantially perpendicularly to the axis of the shaft. Preferably the winder is mounted on the shaft between half and two thirds of the way along measured from the lower end of the shaft.

The cog may be slidable between a state of engagement with the toothed portion of the rod and a disengaged state. In the disengaged state, when the cog has been moved out of contact with the toothed portion or can freewheel, the rod is freely slidable within the shaft subject to it being locked.

The cog may be biased towards the state of engagement, for example by a biasing member such as a coil spring mounted between a housing of the winder and a free end of the cog extending parallel to and about the cog's axis.

The free end of the cog may extend outwardly of a housing of the winder, and a mounting portion of a handle member may be pivotably mounted on the free end adjacent to the housing. The mounting portion may have a substantially planar surface to lie adjacent the housing.

The handle member may have an elongated portion extending from the mounting portion, the elongated portion terminating in a handle portion, the elongated portion and the handle portion being in a substantially L-shaped configuration. A readily grippable handle may be rotatably sleeved over the handle portion.

A handle retainer may be provided on the shaft. The handle retainer may have a bulbous end to retain the elongated portion or the handle member. For example, the handle member may hook over the handle retainer and optionally urge the cog into the disengaged state against any biasing member.

The handle retainer may be integral with a locking pin which is slidable through a hole in the rod and a hole in the shaft when the holes are aligned.

An additional mass, such as a cylinder, may be mounted about the base of the shaft. The mass may provide additional weight to increase the impact force on the receptacle. The mass may be dome shaped to cooperate with the end of the receptacle.

A gauge may be provided on the receptacle having one or more hole depth settings, the gauge being adjustable to select a hole depth setting and prevent the receptacle from being driven further into the ground beyond the selected hole depth. For example, the gauge may be an adjustable clamp mounted on a periphery of the receptacle and may clamp a flange, such as an annulus, provided around all or part of the receptacle. The distance between the lower side of the flange and the cutting edge of the receptacle will be the hole depth.

An integral level indicating means may be provided on the holecutter. Preferably this is a spirit level provided on an upper surface viewable by a user, for example on the receptacle or cylinder.

The holecutter may also provided in a kit comprising a holecutter and a mat having a centrally located hole shaped to match the receptacle, the mat extending laterally to either side of the hole to bear a user's feet.

### BRIEF DESCRIPTION OF THE DRAWINGS

Exemplary embodiments of the invention will now be described, with reference to the accompanying drawings, in which:

FIG. 1 shows an exploded view of a prior art holecutter having an integral expelling means;

FIG. 2 shows a front sectional view of the an embodiment of the holecutter according to the invention;

FIG. 3 shows a side view of the same embodiment of the holecutter according to the invention; and

FIG. 4 shows a plan view of the same embodiment of the holecutter according to the invention.

### DETAILED DESCRIPTION OF THE PREFERRED EMBODIMENTS

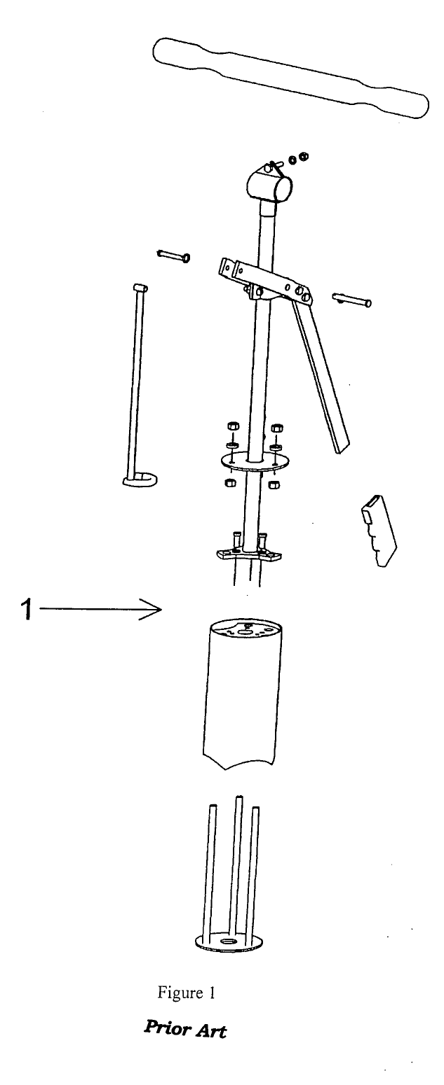

FIG. 1 shows a holecutter 1 as described in the introduction. The holecutter has a hollow cylinder with a cutting edge at a lowermost end, the cylinder having a shaft with handles at one end rigidly fixed to the other end of the cylinder. The lowermost end of the cylinder is open. The other end of the cylinder is closed by a web spanning the interior of the cylinder. The web has regularly spaced apertures spaced around its periphery.

A plate is slidably received in the cylinder. Three legs project perpendicularly from the plate towards the other end of the cylinder. The end of each leg runs through a spaced aperture in the web. A rod is also slidably received within the cylinder, a looped end of which rests on the plate. The distal end of the rod is pivotably attached to a lever mounted about the shaft such that operating the lever drives the rod within the cylinder as described above.

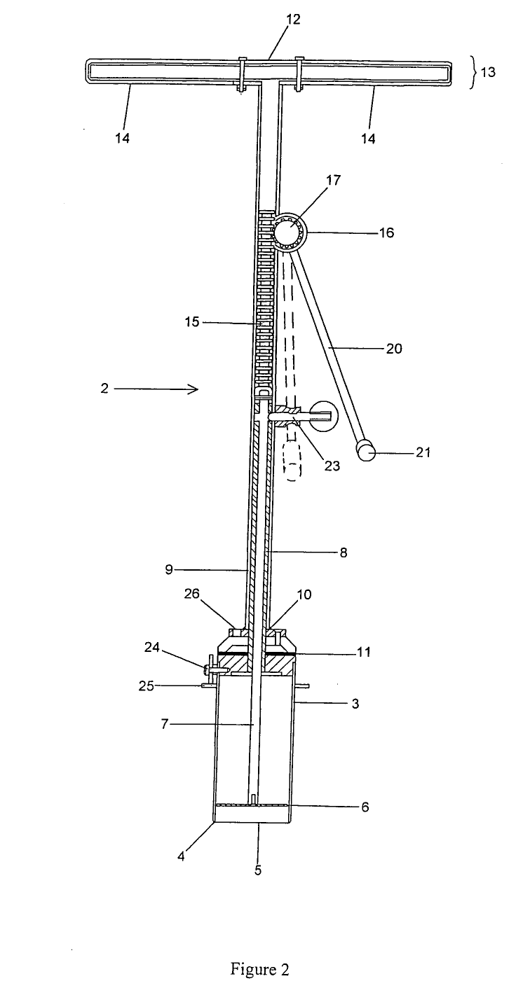

FIG. 2 shows the holecutter 2 according to the invention in a state ready for use.

The holecutter 2 has a cylindrically shaped receptacle 3 with a sharp cutting edge 4 at an end of the receptacle. The end opens into the receptacle via an aperture 5 which has substantially the same radius as the receptacle. The walls of the receptacle are relatively thin so that the radius of the cut hole corresponds to the radius of the receptacle 3. A recess may be provided in the interior of the distal end of the receptacle for collecting waste substances.

A plate 6 mounted on a rigid rod 7 is slidably located within the receptacle 3. The plate 6 is cylindrical and its dimensions substantially match those of interior of the receptacle 3. A small gap may exist between the edge of the plate 6 and interior walls of the receptacle. The plate 6 has an initial position when it is substantially in the upper half of the interior of the receptacle, and an ejected position in which it is in or beyond the lower half of the interior of the receptacle, such as close to the cutting edge. In use the plate is driven towards the aperture 5.

The rod 7 extends upwardly through a centrally located hole in the distal end of the receptacle 3 distal to the aperture 5. The rod 7 is received within a rigid tube 8 mounted on and about the receptacle's axis of rotation.

The majority of the tube 8 is slidably received within a cylindrical shaft 9. A lower end 10 of the shaft 9 rests against an uppermost surface 11 of the receptacle 3. The upper end 12 of the shaft has an end region 13 upon which is mounted opposing handles 14.

A toothed portion 15 is attached to rod 7 where one end of rod 7 protrudes beyond the uppermost end of the tube 8. The toothed portion extends within the shaft 7 towards the handles 14. It is equal to or greater in length than the axial length of the cylinder. Although shown as having annular teeth, the teeth on the toothed portion 15 can have any shape and may only extend over a longitudinal strip on the toothed portion.

A winder 16 is mounted on the shaft about a quarter of the way down from the upper end 12. The winder 16 has a cog 17 engagable with the toothed portion 15. The axis of the cog is perpendicular to the axis of the shaft 9 and the axis of the handles 14.

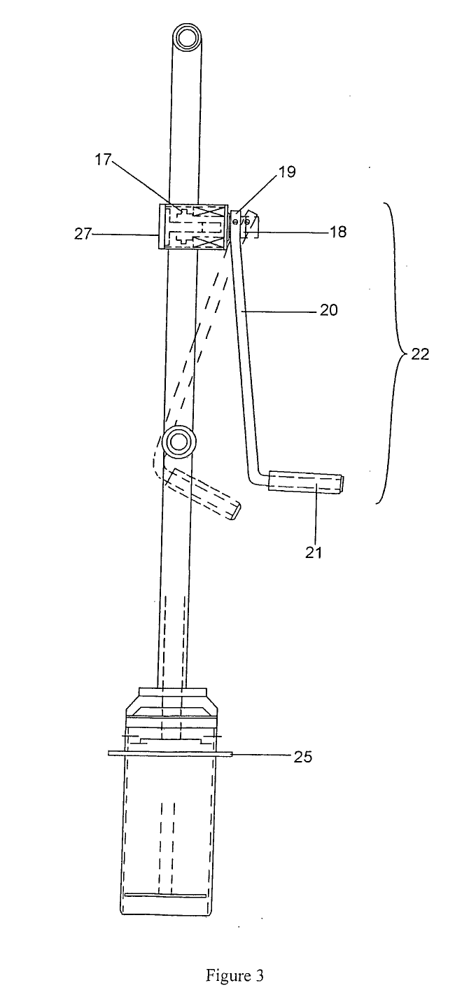

The cog 17 has a free end 18 with no teeth which projects out of a hole in the housing 27 of the winder 16. The cog is slidably mounted within the housing so that it can be brought into and out of engagement with the toothed portion, as shown in dotted lines in FIG. 3.

A coil spring (not shown) is located within the housing between the cog and the housing to bias the cog 17 towards the engaged position.

The free end 18 of the cog 17 is pivotably attached to a mounting portion 19 of a handle member 22. The mounting portion 19 is attached to the free end 18 to lie flush against the housing 27 (FIG. 3). An elongated portion 20 extends away from the mounting portion 19 and terminates in a handle portion 21. The handle portion 21 is at an angle of between about 70 degrees and 120 degrees to the elongated portion 20. A rotatable handle is mounted on the handle portion 21. The axis of the handle portion 21 is substantially parallel to the axis of the cog 17.

A locking pin 23 is provided on the shaft 9. The pin is slidable into holes on the tube 8 and shaft 9 to lock the two together. The pin 23 may also simultaneously lock the rod 7 via a hole in the rod.

The locking pin 23 may also act as a handle retainer. The handle retainer is mounted substantially perpendicularly to the axis of the cog 17. The handle portion 21 can be looped over the handle retainer to store the handle and prevent it from moving. The handle is shown looped over the handle retainer in a stored position in dotted lines in FIG. 3.

When the handle is moved into the stored position, the mounting portion 19 is levered against the housing causing the cog 17 to be moved against the coil spring and into the disengaged position.

A gauge is mounted on one exterior side of the receptacle. The gauge has an adjustable clamp 24 having one or more hole depth settings which grips an annular member 25 that runs around the circumference of the receptacle.

A spirit level 26 is provided on the distal end of the receptacle.

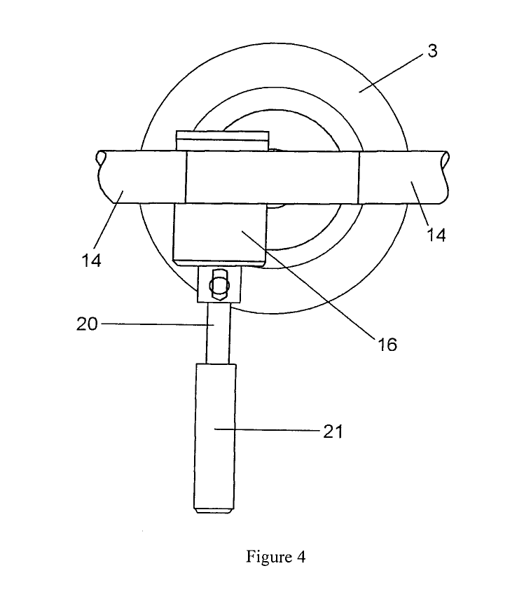

FIG. 4 shows illustrates that the axis of the cog 17 is perpendicular to the axis of the handles 14.

To make a hole, the holecutter is first placed on the relevant surface. Optionally a mat with a guiding hole for receiving the end of the receptacle may be used to accurately position the holecutter. The mat may be fixed temporarily fixed in place, for example by a user standing on the mat.

The gauge is set to the desired hole depth by adjusting the clamp 24 and the holecutter adjusted to make the desired angle with the ground by using the spirit level.

The locking pin 23 is then slid out of the hole on the tube, freeing the shaft 9 to move up and down relative to the receptacle. The handle member remains looped around the handle retainer to hold the cog 17 in the disengaged position.

A user then grips the shaft 9 by the handles 14 and pulls the shaft upwardly to its maximum extent, before letting it drop down under gravity onto the end of the receptacle to deliver an impact. The user can optionally apply an additional force to increase the impact.

The user then repeatedly moves the shaft 9 up and down to apply subsequent impact force to the receptacle and drive it into the ground. When the underside of the annular member 25 comes into contact with the surface or the mat, this indicates that the hole has been cut as desired and so the user returns the shaft 9 to a position in which it is locked by the locking pin 23.

The user then gently twists the holecutter about its axis to free the receptacle within the ground, before pulling the holecutter out of the ground.

The cut material adheres within the receptacle. It is removed by using the handle member. The handle is first disconnected from the handle retainer to move the cog 17 into engagement with the toothed portion. The handle is then rotated to drive the rod and plate within the chamber from its initial position and into its ejected position thereby expelling the cut material. The rod can be reset to it initial position by counter-rotating the handle, or by moving the cog into the disengaged position whereby the rod will reset automatically when another hole is made as the plate comes into contact with the ground as the receptacle is moved down.

In another embodiment (not shown), the rod comprises the guiding means and the ejecting means, so that there is no separate tube projecting from the receptacle. In this case the rod can also be locked to the receptacle 3.

What is claimed is:

1. A holecutter for cutting a hole in the ground and removing cut material, the holecutter comprising
a receptacle;
a cutting edge disposed at an aperture of the receptacle;
an impact means connected to the receptacle and arranged to deliver an impact to the receptacle to drive it into the ground and comprising a grippable shaft slidably mounted on a guiding means which extends away from an end of the receptacle opposed to the aperture; and
an ejecting means disposed to eject the cut material from the receptacle, the ejecting means being movable between an initial position and an ejected position by a geared driving means acting between the guiding means and the impact means.

2. The holecutter according to claim 1, wherein the shaft is selectively lockable to the guiding means or the receptacle.

3. The holecutter according to claim 2, wherein the shaft is lockable to the guiding means when an end of the shaft is brought into contact with the receptacle.

4. The holecutter according to claim 1, further comprising a torque transfer means disposed between the shaft and the receptacle.

5. The holecutter according to claim 1, wherein the ejecting means comprises a rod extending out through a hole in the receptacle and terminating in a first end, the other end of the rod being slidably received within and adapted to cooperate with the interior of the receptacle.

6. The holecutter according to claim 1, wherein the guiding means comprises a rod extending out through a hole in the receptacle and terminating in a first end received within the shaft, the other end of the rod being slidably received within and adapted to cooperate with the receptacle to thereby form the ejecting means.

7. The holecutter according to claim 1, wherein the guiding means comprises a tube mounted on and extending away from the receptacle.

8. The holecutter according to claim 1, wherein the driving means comprises a toothed portion provided on the rod between the first end and other end to engage with a cog of a winder mounted substantially perpendicularly to the shaft.

9. The holecutter according to claim 8, wherein the cog is slidable between a state of engagement with the toothed portion of the rod and a disengaged state.

10. The holecutter according to claim 9, wherein the cog is biased towards the state of engagement.

11. The holecutter according to claim 8, wherein the cog has a free end that extends outwardly of a housing of the winder upon which a mounting portion of a handle member is pivotably mounted adjacent to the housing.

12. The holecutter according to claim 11, wherein the handle member has an elongated portion extending from the mounting portion, the elongated portion terminating in a handle portion, the elongated portion and the handle portion being in a substantially L-shaped configuration.

13. The holecutter according to claim 12, wherein a handle retainer is provided on the shaft.

14. The holecutter according to claim 13, wherein the elongated portion or handle portion is adapted to be hooked onto the handle retainer whereupon hooking the portion onto the retainer applies a force to the cog urging it towards the disengaged state.

15. The holecutter according to claim 14, wherein the handle retainer comprises a locking pin slidable through a hole in the rod and a hole in the shaft when the holes are aligned.

16. The holecutter according to claim 1, having a mass mounted about the base of the shaft.

17. The holecutter according to claim 1, having a gauge on the receptacle having one or more hole depth settings, the gauge being adjustable to select a hole depth setting and prevent the receptacle from being driven further into the ground beyond the selected hole depth.

18. The holecutter according to claim 1, having an integral level indicating means.

19. A kit, comprising:
a holecutter for cutting a hole in the ground and removing cut material, the holecutter including
a receptacle;
a cutting edge disposed at an aperture of the receptacle;
an impact means connected to the receptacle and arranged to deliver an impact to the receptacle to drive it into the ground and comprising a grippable shaft slidably mounted on a guiding means which extends away from an end of the receptacle opposed to the aperture; and
an ejecting means disposed to eject the cut material from the receptacle, the ejecting means being movable between an initial position and an ejected position by a geared driving means acting between the guiding means and the impact means; and
a mat having a centrally located hole shaped to match the receptacle, the mat extending laterally to either side of the hole to bear a user's feet.
